(19) United States
(12) Patent Application Publication
(10) Pub. No.: US 2009/0153404 A1
(43) Pub. Date: Jun. 18, 2009

(54) SINGLE LAYER DUAL BAND ANTENNA WITH CIRCULAR POLARIZATION AND SINGLE FEED POINT

(75) Inventors: Byung-Hoon Ryou, Seoul (KR); Won-Mo Sung, Gyeonggi-do (KR); Jeong-Pyo Kim, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: E.M.W. ANTENNA CO., LTD., Seoul (KR)

(21) Appl. No.: 12/095,900

(22) PCT Filed: May 4, 2006
(86) PCT No.: PCT/KR2006/001685

§ 371 Date: Nov. 25, 2008

(30) Foreign Application Priority Data
Dec. 16, 2005 (KR) 10-2005-0124396

(51) Int. Cl. H01Q 5/01

(52) U.S. Cl. 343/700 MS; 343/848

(57) ABSTRACT

A single-layer dual-band antenna with circular polarization is disclosed. The antenna includes a first radiator formed on the top surface of a substrate and electrically coupled to a feeding element, and a second radiator formed on the top surface of the substrate, spaced apart from the first radiator by a predetermined distance and electromagnetically coupled with the first radiator. The antenna is thin because it has a single-layer structure. Furthermore, there is no deterioration in the radiation characteristic due to interference between the radiators. Moreover, impedances of the radiators can be independently matched at their frequency bands by adjusting the position of a feed point and the relative position of the radiators.

### TECHNICAL FIELD

The present invention relates to a dual-band circular polarization antenna, and more particularly, to a dual-band circular polarization antenna with a small size and easily controllable resonant frequency, which has two radiators formed on the same plane in such a manner as to be spaced apart from each other.

### BACKGROUND ART

Recently, a radio frequency identification (RFID) system has been actively studied. FIG. 10 is a block diagram of a conventional RFID system. The conventional RFID system includes a transponder 100 that is also referred to as an RF tag and a reader/writer 200 having an antenna 210 and a transceiver 220. The transponder 100 is attached to an object that is to be identified, such as products, vehicles, the human body, animals and so on, and stores identification information and state information of the object. The transponder 100 can perform wireless communication with the reader 200 through an antenna (not shown) included therein. The reader 200 transmits electromagnetic waves through the antenna 210 to activate the transponder 100 and reads data stored in the transponder 100 or writes new data to the transponder 100. In the conventional RFID system, antennas must be respectively set in the transponder 100 and the reader 200 for wireless communication.

The antenna of the transponder 100 is disclosed in Korean Patent Laid-Open Publication Nos. 2005-78157 and 2005-111174, and PCT International Patent WO 2003/105063. It is preferable that the antenna of the transponder 100 is small and compact, and thus a loop antenna is used as the antenna of the transponder 100.

The loop antenna, thus the antenna of the transponder 100 has linear polarization characteristic. Accordingly, it is preferable that the antenna 210 of the reader 200 also has the linear polarization characteristic in order to efficiently communicate with the transponder 100. In the RFID system, however, the transponder 100 and the reader 200 are not always located in parallel with each other. In particular, the transponder 100 can be located at a random angle to the reader 200 when communication between the transponder 100 and the reader 200 is performed without having a user s operation, for example, in the case of distribution system or transportation system. To achieve stabilized communication between the transponder 100 and the reader 200 while the transponder 100 and the reader 200 are not aligned with each other, it is preferable to use an antenna having circular polarization characteristic as the antenna 210 of the reader 200.

Conventional circular polarization antennas include a corner truncated rectangular patch antenna, a circular patch antenna, and a rectangular patch antenna using two feeding elements having a phase difference of 90 between them.

The RFID system uses various frequency bands including 125 KHz, 13.56 MHz, 433 MHz, 900 MHz and 2.45 GHz according to communication distance and communication rate. While the transponder 100 can operate only at a specific frequency, the reader 200 must operate at various frequencies in order to recognize a variety of transponders. Particularly, the antenna 210 of the reader 200 must have multi-band characteristic.

A multi-band circular polarization antenna having multi-band characteristic using a plurality of radiators is disclosed in Korean Patent Laid-Open Publication No. 2004-58099. This antenna has separate feeding elements for the respective radiators, and thus its configuration is complicated and the manufacturing cost is high. Furthermore, this antenna has a narrow bandwidth and a low gain.

A multi-band circular polarization antenna, which is constructed in such a manner that two radiators are respectively formed on the top surface and the bottom surface of a dielectric, a feeding unit is formed only at one of the radiators, and signal is fed to the other radiator by means of electromagnetic coupling between the two radiators, is disclosed in Korean Utility model patent No. 377493 granted to the applicant of the present invention. This multi-band circular polarization antenna can be manufactured at a low cost because it uses a single feeding point. Furthermore, the bandwidth and gain of the multi-band circular polarization antenna are improved through coupling between the radiators. However, it is difficult to accurately control resonant frequencies of the radiators because the radiators do not use respective feeding units. Furthermore, the height of the antenna is increased because the antenna has a stacked structure. Moreover, since the radiators are stacked, the upper radiator affects the radiation of the lower radiator to reduce the gain of the lower radiator and deteriorate the overall radiation characteristic due to interference between the two radiators.

### DISCLOSURE OF INVENTION

### Technical Problem

Accordingly, the present invention has been made to solve the above-mentioned problems occurring in the conventional art, and a primary object of the present invention is to provide a thin dual-band circular polarization antenna having multi-band characteristic, a wide bandwidth and a high gain.

Another object of the present invention is to provide a dual-band circular polarization antenna whose resonant frequencies and impedance can be accurately controlled.

### Technical Solution

To accomplish the objects of the present invention, there is provided a dual-band patch antenna comprising a first radiator and a second radiator formed of a conductive material on the top surface of a substrate, and a conductive ground plane formed on the bottom surface of the substrate, wherein the first radiator is electrically coupled to a feeding element, and the second radiator is spaced apart from the first radiator by a predetermined distance and electromagnetically coupled to the first radiator without being directly electrically coupled to the feeding element.

The second radiator may surround the first radiator.

The center point of the first radiator, the center point of the second radiator and the coupling point of the first radiator and the feeding element may be located on the same straight line.

The first radiator and the second radiator may have the same outer shape.

The first radiator and the second radiator may be corner truncated rectangular patches.

The first radiator may be coupled to the feeding element through a coaxial cable.

According to another aspect of the present invention, there is provided a method of adjusting the resonant frequency of a dual-band patch antenna including a first radiator and a second radiator formed of a conductive material on the top surface of a substrate, and a conductive ground plane formed on the bottom surface of the substrate, wherein the first radiator is electrically coupled to a feeding element, and the second radiator is spaced apart from the first radiator by a predetermined distance and electromagnetically coupled to the first radiator without being directly electrically coupled to the feeding element, the method comprising the step of controlling the coupling point of the first radiator and the feeding element to adjust a first resonant frequency of the antenna, and controlling the relative position of the second radiator and the first radiator to adjust a second resonant frequency of the antenna.

The controlling the coupling point may comprise adjusting the distance between the center of the first radiator and the coupling point of the first radiator and the feeding element.

The controlling the relative position may comprise adjusting the distance between the center of the second radiator and the center of the first radiator.

### ADVANTAGEOUS EFFECTS

According to the present invention, a thin dual-band circular polarization antenna having a simple structure can be obtained by forming radiators in a single layer and using a single feeding structure. The dual-band circular polarization antenna has a wide bandwidth and a high gain through coupling.

Furthermore, the resonant frequencies and impedance of the dual-band circular polarization antenna can be correctly adjusted by independently controlling the two radiators.

### BRIEF DESCRIPTION OF THE DRAWINGS

Further objects and advantages of the invention can be more fully understood from the following detailed description taken in conjunction with the accompanying drawings, in which:

FIG. 1 illustrates a corner truncated rectangular patch antenna;

FIG. 2 is a plan view of a dual-band circular polarization antenna according to an embodiment of the present invention;

FIG. 3 is a cross-sectional view taken along line A-A of FIG. 2;

FIG. 4 is a diagram for explaining the control of the resonant frequency of the dual-band circular polarization antenna according to an embodiment of the present invention;

FIG. 5 illustrates a dual-band circular polarization antenna of an exemplary realization of the present invention;

FIG. 6 is a graph exhibiting return loss characteristic at 900 MHz band according to a variation in the size of a radiator of an exemplary realization of the present invention;

FIG. 7 is a graph exhibiting return loss characteristic at 2.45 GHz band according to a variation in the size of the radiator of an exemplary realization of the present invention;

FIG. 8 is a graph exhibiting return loss characteristics of the dual-band circular polarization antenna of an exemplary realization of the present invention at 900 MHz and 2.45 GHz bands;

FIG. 9 illustrates dual-band circular polarization antennas according to other embodiments of the present invention; and

FIG. 10 is a block diagram of a conventional RFID system.

### BEST MODE FOR CARRYING OUT THE INVENTION

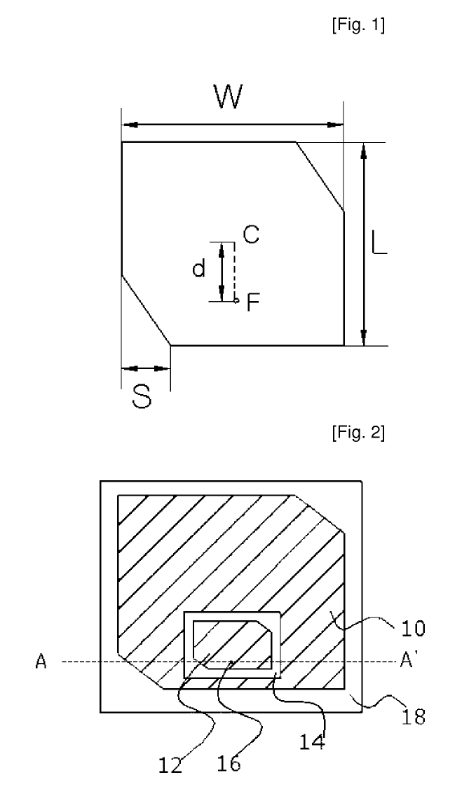

Before providing detailed description of specific embodiments of the present invention, a corner truncated rectangular patch antenna used as a radiator of a dual-mode circular polarization antenna according to an embodiment of the present invention will now be explained. FIG. 1 illustrates the corner truncated rectangular patch antenna.

Referring to FIG. 1, a rectangular patch has a length of L and a width of W and is fed at a feed point F. The resonant frequency of the rectangular patch antenna is roughly determined by the length L of the rectangular patch. The length L of the rectangular patch is set to approximately λ/2 when the resonant wavelength of the antenna is λ. The width W of the rectangular patch is proportional to the bandwidth of the antenna. In the present embodiment, the length L and the width W of the rectangular patch may be equal to each other. Two opposite corners of the rectangular patch are truncated in the form of a right-angled (and equilateral) triangle having a side length s. Electrical lengths from the feed point F to both sides of the rectangular patch are different from each other because of the truncated portions, and thus two resonant modes are obtained. Since circular polarization occurs when the two resonant modes have a phase difference of 90 between them, the electrical length of the rectangular patch and a circular polarization generating frequency can be controlled by adjusting the side length s of the right-angled triangle. Furthermore, right hand circular polarization (RHCP) and left hand circular polarization (LHCP) can be selectively generated by controlling the truncated portions and feed point.

The feed point F is spaced apart from the center C of the rectangular patch by a distance d. Signal can be fed to the rectangular patch through a coaxial cable. The impedance of the radiator, that is, the rectangular patch, can be determined by the distance d between the feed point F and the center C of the patch. Accordingly, impedance matching can be performed and the resonant frequency of the radiator can be controlled by varying the distance d between the feed point F and the center C of the patch. In general, as the distance d increases, the resonant frequency of the radiator decreases and the impedance of the radiator increases.

The dual-mode circular polarization antenna using the aforementioned patch radiator according to an embodiment of the present invention will now be explained.

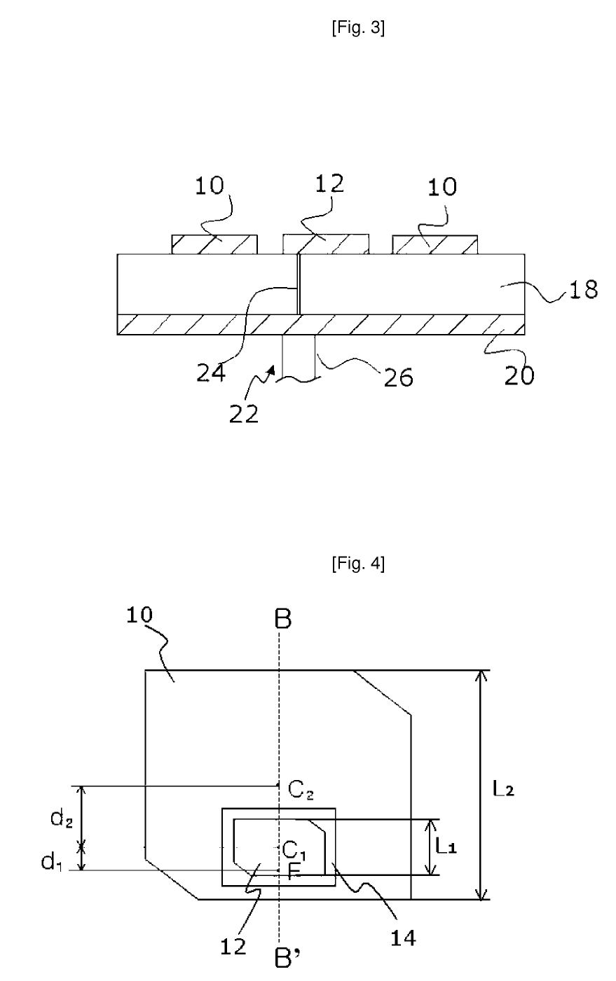

FIG. 2 is a plan view of the dual-band circular polarization antenna according to an embodiment of the present invention, and FIG. 3 is a cross-sectional view taken along line A-A′ of FIG. 2.

Referring to FIGS. 2 and 3, the dual-mode circular polarization antenna according to an embodiment of the present invention includes a dielectric substrate 18, first and second radiators 12 and 10 formed on the top surface of the dielectric substrate 18, and a ground plane 20 formed on the bottom surface of the dielectric substrate 18 to constitute a patch antenna. The substrate 18 is made of a material with a high dielectric constant to reduce the effective wavelength and size of the antenna or made of a material with a low dielectric constant to improve the gain of the antenna. The first and second radiators 10 and 12 and the ground plane 20 are made of a conductive material. The radiators 10 and 12 and the ground plane 20 may be separately fabricated through a pressing process and combined with the substrate 18. Otherwise, the radiators 10 and 12 and the ground plane 20 may be directly formed on the substrate 18 using plating or etching processes. The radiators 10 and 12 and the ground plane 20 may be fabricated and combined with the substrate 18 using well-known techniques.

The first radiator 12 can be a corner truncated rectangular patch as described above with reference to FIG. 1. The first radiator 12 is smaller than the second radiator 10 and determines the higher resonant frequency of the antenna. Accordingly, the higher resonant frequency of the antenna mainly depends on the size of the first radiator 12. The resonant frequency by the first radiator 12, i.e. the higher resonant frequency and impedance of the first radiator 12 can be controlled by adjusting the position of a feed point, which will be explained later.

The first radiator 12 can be fed at a feed point 16 through a coaxial cable 22. However, the feeding means is not limited to the coaxial cable. An outer conductor 26 of the coaxial cable 22 may be connected with the ground plane 20 and an inner conductor 24 of the coaxial cable 22 may penetrate the substrate 18 and be connected to the first radiator 12 at the feed point 16. It is possible to feed to the first radiator 12 by means of electromagnetic coupling without directly connecting the inner conductor 24 of the coaxial cable 22 to the first radiator 12. As described above with reference to FIG. 1, the resonant frequency and impedance of the first radiator 12 can be controlled by adjusting the position of the feed point 16. The centers of the first and second radiators 12 and 10 and the feed point 16 can be located on the same straight line such that the resonant frequencies of the first and second radiators 12 and 10 can be easily adjusted.

The second radiator 10 can have the same form as the first radiator 12, that is, the form of a corner truncated rectangular patch. Accordingly, the resonant frequency and impedance of the second radiator 10 are adjusted in the same manner as the resonant frequency and impedance of the first radiator 12 are adjusted as described below. This facilitates the control of antenna characteristic.

The second radiator 10 is larger than the first radiator 12 so that it mainly affects the lower resonant frequency of the antenna. Accordingly, the lower resonant frequency of the antenna can be controlled by adjusting the size of the second radiator 10. Furthermore, the resonant frequency and impedance of the second radiator 10 can be controlled by adjusting the relative position of the first and second radiators 12 and 10, as below.

While FIG. 2 illustrates that truncated corners of the second radiator 10 correspond to truncated corners of the first radiator 12, opposite corners of the second radiator 10 can be truncated. The first radiator 12 and the second radiator 10 may be formed on the same plane, and an opening 14 may be formed in the second radiator 10. The first radiator 12 may be placed in the opening 14. Accordingly, the first and second radiators 12 and 10 can be arranged on the same plane without being overlapped with each other and a decrease in the gains of the first and second radiators 12 and 10 can be prevented.

The second radiator 10 may have no additional feed point and be spaced apart from the first radiator 12 by a predetermined distance. Accordingly, feeding to the second radiator 10 is achieved via electromagnetic coupling between the first and second radiators 12 and 10. The electromagnetic coupling induces capacitance, and thus the bandwidth of the antenna is extended and the gain of the antenna is increased. Furthermore, the antenna structure can be simplified because the second radiator 10 has no additional feed point.

The control of the resonant frequency and impedance of the dual-mode circular polarization according to an embodiment of the present invention will now be explained with reference to FIG. 4.

Referring to FIG. 4, the first radiator 12 and the second radiator 10 respectively have lengths L1 and L2. The first radiator 12 has a center point C1 and is fed at the feed point F. The second radiator 10 has a center point C2. The points C1, F and C2 are located on one straight line B-B′. The feed point F is spaced apart from the center point C1 of the first radiator 12 by a distance d1 and the center point C1 of the first radiator 12 is spaced apart from the center point C2 of the second radiator 10 by a distance d2.

As described above, the resonant frequencies of the first and second radiators 12 and 10 are determined by the sizes L1 and L2 of the first and second radiators 12 and 10. The size L1 of the first radiator 12 determines the higher resonant frequency and the size L2 of the second radiator 10 determines the lower resonant frequency, mainly. The sizes L1 and L2 of the first and second radiators 12 and 10 are not related to each other so that the resonant frequencies of the first and second radiators can be independently controlled.

The correct resonant frequency and impedance of the first radiator 12 are determined by the distance d1 between the feed point F and the center point C1 of the first radiator 12. As described above, the resonant frequency of the first radiator 12 decreases and its impedance increases as the distance d1 increases. The distance d1 can be adjusted by moving the feed point F on the straight line B-B. The correct resonant frequency and impedance of the second radiator 10 are determined by the distance d1+d2 between the feed point F and the center point C2 of the second radiator 10, and the distance d1+d2 may be controlled by adjusting the distance d2. The distance d2 may be adjusted by moving the first radiator 12 on the straight line B-B inside the opening 14. Alternatively, the first radiator 12 may be fixed and the second radiator 10 moved.

That is, the distance d2 may be adjusted by controlling only the relative distance between the first and second radiators 12 and 10 without adjusting the feed point F, remaining the distance d1 not changed. Accordingly, the resonant frequency and impedance of the first radiator 12 are not varied when the resonant frequency and impedance of the second radiator 10 are controlled. Thus, it is possible to independently calibrate the resonant frequencies of the first and second radiators 12 and 10 and independently match the their impedances.

According to the present embodiment, a thin antenna can be obtained because the two radiators are formed on the same plane. Furthermore, the two radiators are not overlapped with each other, and thus a decrease in the gain of the antenna due to interference of the two radiators can be prevented. Moreover, the resonant frequencies of the two radiators can be independently controlled by adjusting the sizes of the two radiators. In addition, the resonant frequencies of the two radiators can be accurately controlled and impedances at a high frequency and a low frequency can be easily matched by adjusting the position of the feed point and arrangement of the two radiators.

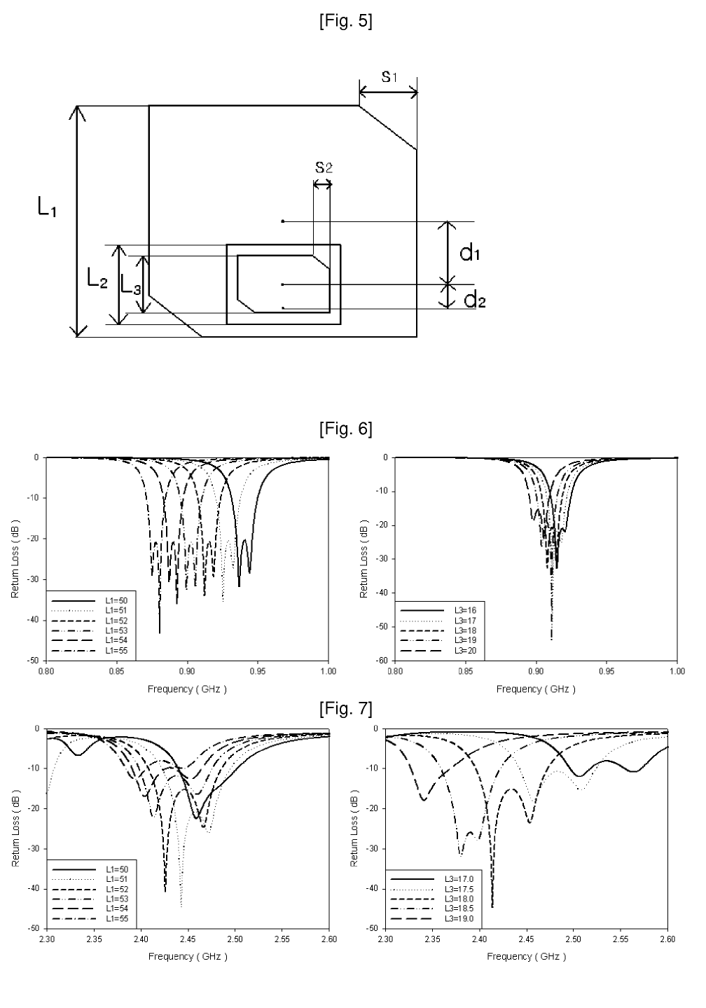

The dual-mode circular polarization antenna according to an embodiment of the present invention was actually realized and simulated. The realized dual-mode circular polarization antenna is shown in FIG. 5. The antenna is manufactured such that it operates at 900 MHz and 2.45 GHz bands. The dimension of the antenna is represented in the following table.

TABLE 1

| L1 | L2 | L3 | s1 |
|---|---|---|---|
| 50-55 mm | 18-22 mm | 16-20 mm | 4 mm |

| s2 | d1 | d2 |
|---|---|---|
| 1.2 mm | 6.5 mm | 2.2 mm |

The antenna uses a dielectric substrate having a dielectric constant of approximately 8 and a size of 80×80×6 mm³, and a distance between radiators is 1 mm.

A return loss at 900 MHz band was measured while varying L1 and L3 and the measurement result is shown in FIG. 6. Referring to FIG. 6, it was confirmed that the return loss at 900 MHz band is mainly affected by the size L1 of the first radiator. A return loss at 2.45 GHz was measured while varying L1 and L3 and the measurement result is shown in FIG. 7. Referring to FIG. 7, it was confirmed that the return loss at 2.45 GHz band mainly depends on the size L3 of the second radiator.

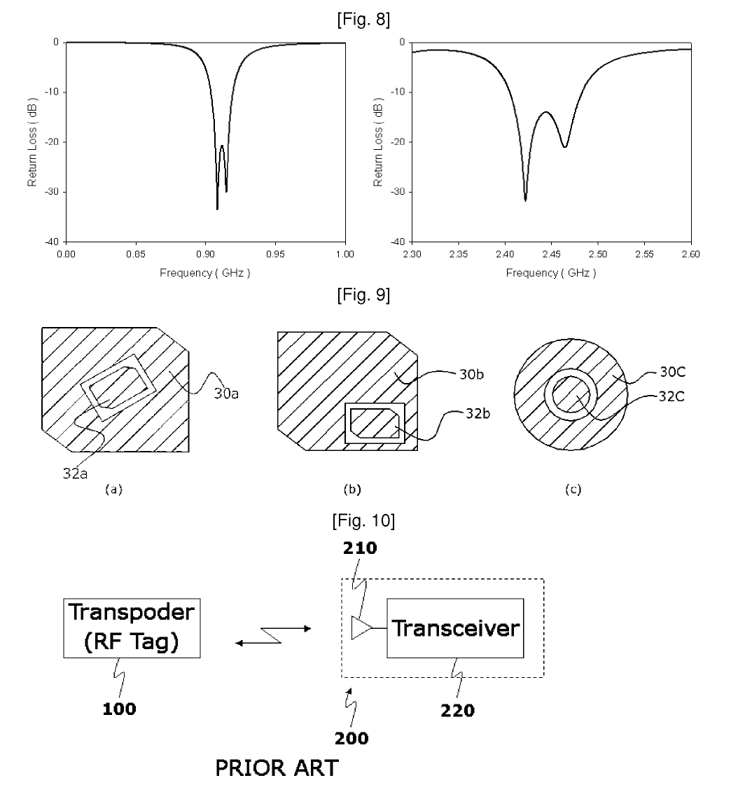

It was determined that L1=52.3 mm and L3=18 mm are optimum sizes based on the measurement results. Return losses of the antenna having the optimum sizes at 900 MHz and 2.45 GHz bands are shown in FIG. 8. As shown in FIG. 8, the antenna exhibited dual-band characteristic at 900 MHZ and 2.45 GHz bands. The antenna had a gain of 2.95 dBic at 912 MHz and a gain of 4.6 dBic at 2441.5 MHz.

Dual-band circular polarization antennas according to other embodiments of the present invention will now be explained with reference to FIG. 9. Referring to FIG. 9(a), a first radiator 32a and a second radiator 30a may be located at a predetermined angle to each other such that the radiators don t have same bisector. Referring to FIG. 9(b), a first radiator 32b may not be located at the center of a second radiator 30b and arranged at one side of the second radiator 30b. Referring to FIG. 9(c), radiators 30c and 32c may have the form of a circular patch.

In all the antenna structures shown in FIGS. 9(a), 9(b) and 9(c), the center points of the radiators and a feed point are located on one straight line so that resonant frequencies and impedances of the radiators can be independently controlled. Furthermore, the resonant frequencies and impedances of the radiators can be independently controlled by adjusting the position of the feed point and the relative position of the radiators even when the center points of the radiators and the feed point are not located on one straight line.

While the present invention has been particularly shown and described with reference to exemplary embodiments thereof, it is to be understood that the invention is not limited by those embodiments. Rather, it will be apparent to those skilled in the art that various changes in form and details, such as changes in the shapes of the radiators and feeding method, may be made therein without departing from the spirit and scope of the present invention as defined by the following claims.

1. A dual-band patch antenna comprising:
a first radiator and a second radiator formed of a conductive material on the top surface of a substrate; and
a conductive ground plane formed on the bottom surface of the substrate,
wherein the first radiator is electrically coupled to a feeding element, and the second radiator is spaced apart from the first radiator by a predetermined distance and electromagnetically coupled to the first radiator without being directly electrically coupled to the feeding element.

2. The dual-band patch antenna according to claim 1, wherein the second radiator surrounds the first radiator.

3. The dual-band patch antenna according to claim 2, wherein the center point of the first radiator, the center point of the second radiator and the coupling point of the first radiator and the feeding element are located on the same straight line.

4. The dual-band patch antenna according to claim 2, wherein the first radiator and the second radiator have the same outer shape.

5. The dual-bland patch antenna according to claim 2, wherein the first radiator and the second radiator are corner truncated rectangular patches.

6. The dual-band patch antenna according to claim 1, wherein the first radiator is coupled to the feeding element through a coaxial cable.

7. A method of adjusting the resonant frequency of a dual-band patch antenna including a first radiator and a second radiator formed of a conductive material on the top surface of a substrate, and a conductive ground plane formed on the bottom surface of the substrate, wherein the first radiator is electrically coupled to a feeding element, and the second radiator is spaced apart from the first radiator by a predetermined distance and electromagnetically coupled to the first radiator without being directly electrically coupled to the feeding element, the method comprising the steps of:
controlling the coupling point of the first radiator and the feeding element to adjust a first resonant frequency of the antenna; and
controlling the relative position of the second radiator and the first radiator to adjust a second resonant frequency of the antenna.

8. The method according to claim 7, wherein the controlling the coupling point comprises adjusting the distance between the center of the first radiator and the coupling point of the first radiator and the feeding element.

9. The method according to claim 7, wherein the controlling the relative position comprises adjusting the distance between the center of the second radiator and the center of the first radiator.
